(19) United States
(12) Patent Application Publication
(10) Pub. No.: US 2013/0024573 A1
(43) Pub. Date: Jan. 24, 2013

(54) SCALABLE AND EFFICIENT MANAGEMENT OF VIRTUAL APPLIANCE IN A CLOUD

(71) Applicants: Takayuki Kushida, Tokyo (JP); Rajeev Puri, Huntersville, NC (US); Sambit Sahu, Hopewell Junction, NY (US); Upendra Sharma, Amherst, NY (US)

(72) Inventors: Takayuki Kushida, Tokyo (JP); Rajeev Puri, Huntersville, NC (US); Sambit Sahu, Hopewell Junction, NY (US); Upendra Sharma, Amherst, NY (US)

(73) Assignee: INTERNATIONAL BUSINESS MACHINES CORPORATION, Armonk, NY (US)

(21) Appl. No.: 13/184,659

(22) Filed: Jul. 18, 2011

(51) Int. Cl. G06F 15/173

(52) U.S. Cl. 709/226

(57) ABSTRACT

Data representative of a set of requests for cloud computing services is obtained. The services are to be provided by a cloud having a plurality of base images. The requests specify requested subsets of the base images. Data representative of provisioning and de-provisioning costs associated with the plurality of base images is obtained. Then, k composite virtual appliances are pre-provisioned. The composite virtual appliances include virtual appliance subsets of the base images, based on cost minimization, in accordance with the data representative of the set of requests and the data representative of the provisioning and de-provisioning costs.

### FIELD OF THE INVENTION

The present invention relates to the electrical, electronic and computer arts, and, more particularly, to cloud computing and the like.

### BACKGROUND OF THE INVENTION

Cloud computing is poised to become a disruptive technology and potentially change the way information technology (IT) services are provided and managed. While several models are emerging and quite a few definitions are being used to describe this landscape, the most typical usage scenario involves a user requesting a computing resource with a set of software and/or applications without requiring the user to invest in the infrastructure. An Infrastructure as a Service (IaaS) cloud with certain level of service supports such a model, wherein a virtual server is provided to the user as per the user's request. This approach also typically allows users to request applications; for example, DB2® database software and WebSphere® Application Server (WAS) software (registered marks of International Business Machines Corporation, Armonk, N.Y. USA) in addition to a central processing unit (CPU) with appropriate memory and disk sizing. It should be noted that DB2 database software and WAS software are non-limiting examples of database and application server software. A provider may offer a service catalog wherein a set, including an operating system (OS), middleware, and applications, may be made available to the users to choose from. A user may choose a set of software while requesting the virtual resource. In this scenario, the cloud provider pre-builds a set of images called virtual appliances that can be used to automatically provision a virtual server with the desired software image.

### SUMMARY OF THE INVENTION

Principles of the invention provide techniques for scalable and efficient management of virtual appliance(s) in a cloud. In one aspect, an exemplary method includes the step of obtaining data representative of a set of requests for cloud computing services. The services are to be provided by a cloud having a plurality of base images. The requests specify requested subsets of the base images. Further steps include obtaining data representative of provisioning and de-provisioning costs associated with the plurality of base images; and pre-provisioning k composite virtual appliances including virtual appliance subsets of the base images, based on cost minimization, in accordance with the data representative of the set of requests and the data representative of the provisioning and de-provisioning costs.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments may provide one or more of the following advantages:

less storage

less time to achieve the right configuration

less time to provision

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing node according to an embodiment of the present invention;

FIG. 2 depicts a cloud computing environment according to an embodiment of the present invention:

FIG. 3 depicts abstraction model layers according to an embodiment of the present invention;

FIG. 4 presents an exemplary flow chart, according to an aspect of the invention, according to an aspect of the invention;

FIG. 5 presents an exemplary flow chart, according to an aspect of the invention; and

FIG. 6 is an exemplary system block diagram, according to an aspect of the invention.

### DETAILED DESCRIPTION OF PREFERRED EMBODIMENTS

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating system is and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

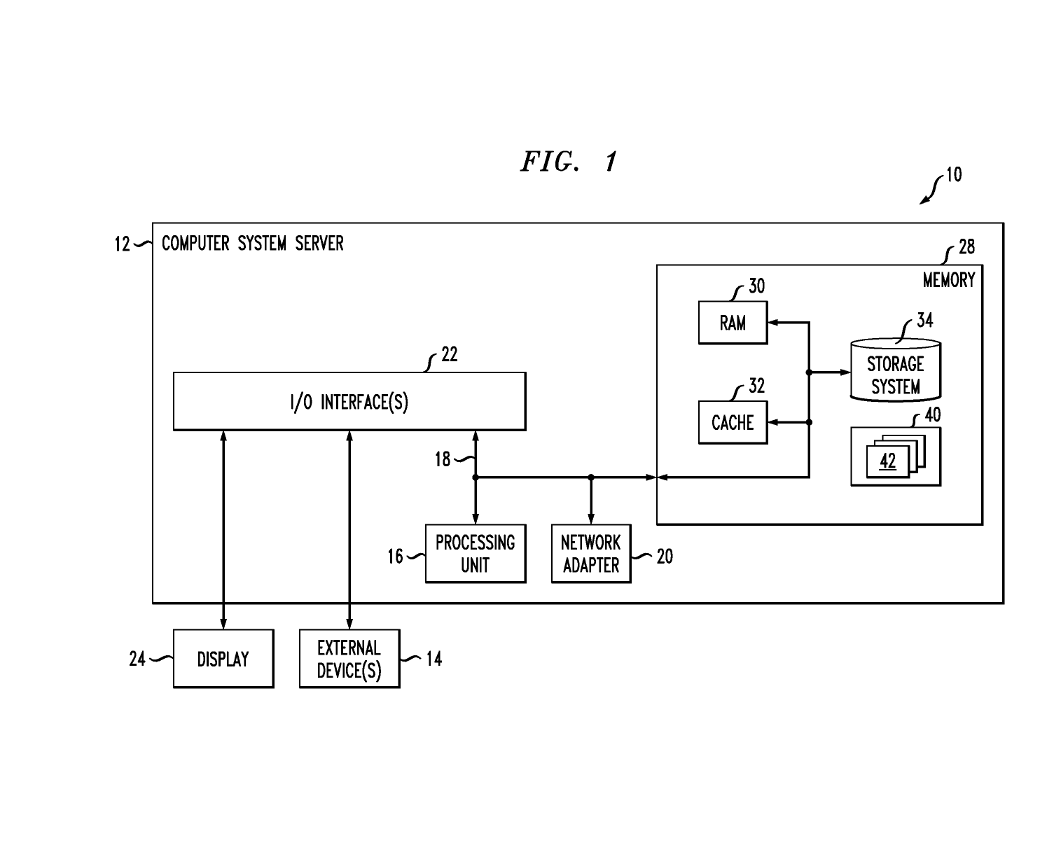

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth herein.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects. components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus. Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules. and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

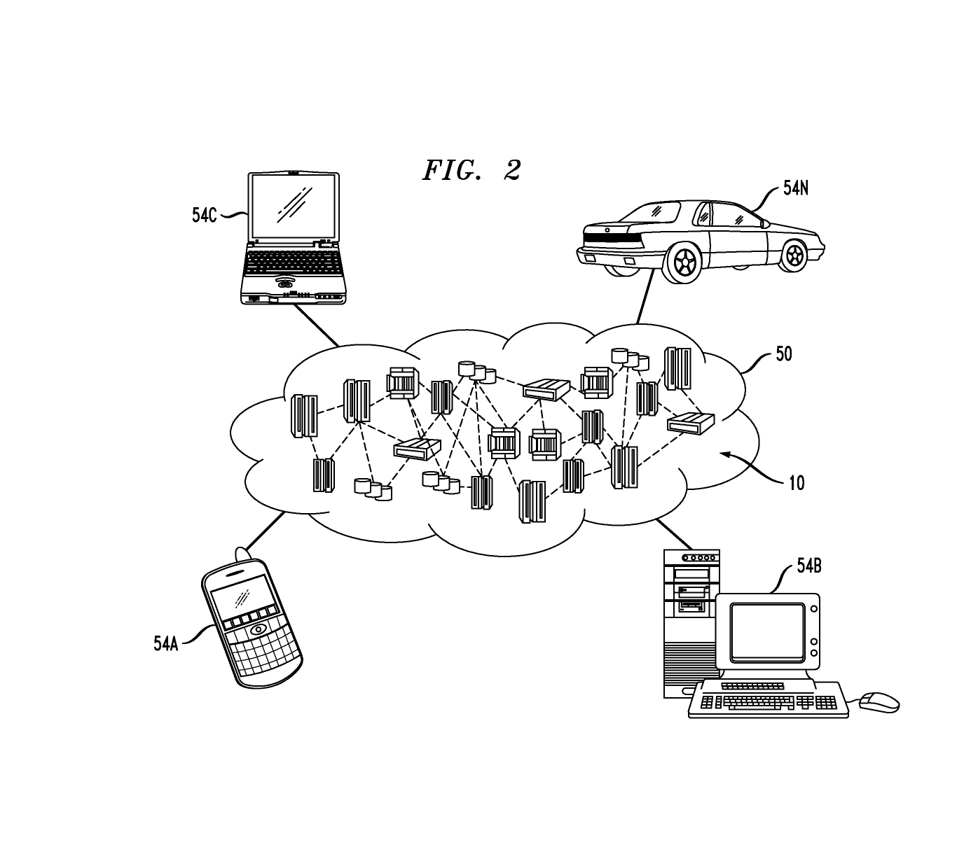

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

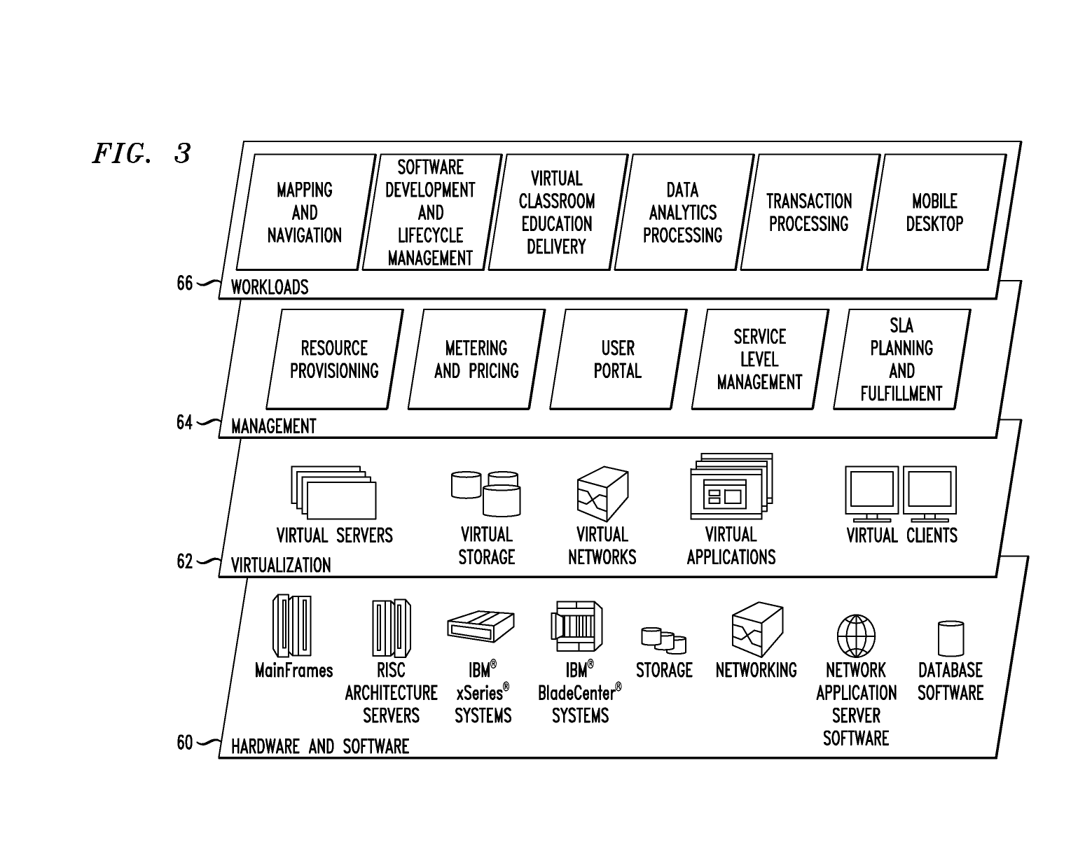

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

As noted, cloud computing is poised to become a disruptive technology and potentially change the way IT services are provided and managed. While several models are emerging and quite a few definitions are being used to describe this landscape, the most typical usage scenario involves a user requesting a computing resource with a set of software and/or applications without requiring the user to invest in the infrastructure. An Infrastructure as a Service (IaaS) cloud with a certain level of service supports such a model, wherein a virtual server is provided to the user as per the user's request. This approach also typically allows users to request applications; for example, DB2® database software and WebSphere® Application Server (WAS) software (registered marks of International Business Machines Corporation, Armonk, N.Y., USA) in addition to a central processing unit (CPU) with appropriate memory and disk sizing. It should be noted that DB2 database software and WAS software are non-limiting examples of database and application server software. A provider may offer a service catalog wherein a set, including an operating system (OS), middleware, and applications, may be made available to the users to choose from. A user may choose a set of software while requesting the virtual resource. In this scenario, the cloud provider pre-builds a set of images called virtual appliances that can be used to automatically provision a virtual server with the desired software image. In one or more embodiments, the virtual appliances reside in virtualization layer 62.

A consideration in this case is how to support user requests without supporting a very large number of virtual appliances. Consider the case where there are N base images. If it is desired to support any possible combinations of images, it may be necessary to keep an exponential number of images, which is expensive from both the storage and the maintenance viewpoints. That is, if it is desired to support any possible combinations of N base images, 2^{N}−1 virtual appliances would theoretically be required.

One or more embodiments provide an efficient approach towards a cost effective solution for automating users' requests for software provisioning with a significantly smaller number of virtual appliances than in current techniques (the catalog in current public clouds typically includes only monolithic appliances; i.e., “all or nothing” with no possibility of composition). One or more embodiments account for practical system constraints and requirements. A non-limiting exemplary model and solutions are described below.

One significant aspect of one or more embodiments is the dynamic tracking of user requests to identify a set of composite virtual appliances that should be kept, such that the overall cost for supporting provisioning is minimized while respecting the system's constraints and requirements. A formal description of one non-limiting exemplary model, according to one embodiment, follows.

Denote the base images (i.e., DB2, WAS, CentOS enterprise-class LINUX® operating system distribution, etc.) by a set {Iₖ}, k=1, . . . , N. LINUX is a registered mark of Linus Torvalds, Portland, OR 97219 USA. In this regard, as noted above, DB2 software and WAS software are non-limiting examples of database and application server software. Furthermore, CentOS is a non-limiting example of an operating system. Even further, database software, application server software, and operating systems are non-limiting examples of images.

In one or more embodiments, users request a subset from these base images. Request Rᵢ includes a set of images from the base images. If a composite image that matches this subset is available a priori, then the cost to provision is minimized due to full automation as well as reduced latency. Whenever there is no exact match, the provider typically needs to customize (modify) the configuration of a chosen a priori composite image or to create a new composite image from several base images to support the requested subset.

In the example, every base image Iₖ has a provision (time and/or labor) cost Aᵢ, meaning that if a provider has to install this image instead of booting from a virtual appliance, the provider will incur this provision cost; and a de-provision (time and/or labor) cost D₁, meaning that if the provider has to uninstall this image from a composite install, this de-provision cost will be incurred. The skilled artisan can determine the provision and de-provision costs, for example, via benchmarking based on skill levels, typical required times, and associated hourly rates. Such benchmarking can in turn be based on prior experience and/or statistics (in some cases, the estimates may well be stochastic rather than deterministic). Furthermore, every piece of base software and the composite images have an associated disk size requirement, say, Sᵢ. In addition, every piece of base software has an update frequency Uᵢ, meaning the number of updates that arrive every unit time (in general, a value greater than or equal to zero). When an update arrives, the image as well as any composite image containing that virtual image is invalidated, meaning it cannot be installed before patching. There a patching cost associated with the composite image.

An exemplary, non-limiting objective of one or more embodiments can be stated as follows: Given that the system has a finite amount of storage, and hence can only keep a handful of virtual appliances, and given also the aforementioned invalidation rate for the images, which set(s) should be built a priori such that the cost for provisioning can be minimized?

One or more embodiments account for the invalidation rate and the cost for provisioning and de-provisioning, to determine the dynamic set of images that should be kept to efficiently support user requests for composite software requests.

In a non-limiting example, a method, according to an aspect of the invention, includes two distinct phases.

Provision phase: In this phase, the provider examines the catalog of pre-built images and chooses the composite image that minimizes the provision cost, given the two operations (i.e., the install and uninstall costs in the case of customization) to satisfy the requested set. That is to say, the provider has received an individual request and is now picking which one of the virtual appliances is best suited (possibly with modification) to meeting the request. An exemplary detailed flow diagram will be presented below.

Catalog phase: In this phase, a decision is made as to which set of images should be pre-built so as to minimize the provision cost given the past history and prediction about the request workload. This is a dynamic process. In some instances, the catalog contents may initially be based on an estimate by a human expert. Then, as the system is used, the catalog is updated periodically based on the requests that have been processed.

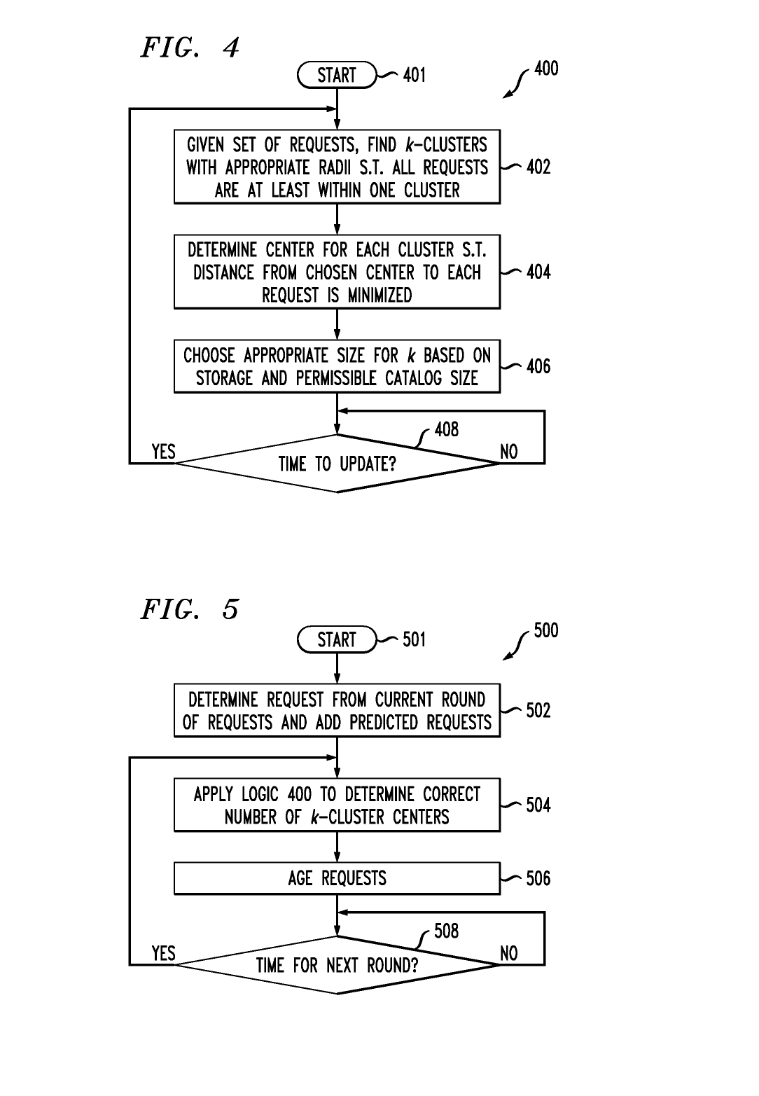

With regard to a technique for determining the catalog, refer to the flow chart 400 of FIG. 4, which begins at 401. In step 402, given a set of requests, find k-clusters with appropriate radii such that all requests are at least within one cluster. Step 402 is carried out based on a suitably selected initial value of k, the number of clusters. A number of different k-clustering techniques can be employed. As will be appreciated by the skilled artisan, in a two-dimensional case of k-means, each point of a plurality of points has an X-value and a Y-value. A total number, k, of circles are drawn. Each of the points belongs to one of the circles. The technique is readily extended to n dimensions, representing pertinent attributes in an equilibrium space. For example, in three-dimensional space, draw k spheres, and each point belongs to one of them.

Reference is made to the article “Fundamental Effects of Clustering on the Euclidean Embedding of Internet Hosts,” by Sanghwan Lee et al., presented at NETWORKING '07 Proceedings of the 6th international IFIP-TC6 conference on Ad Hoc and sensor networks, wireless networks, 2007, the complete contents of which are expressly incorporated herein by reference in their entirety for all purposes.

For illustrative convenience, reference to the two-dimensional case will continue, with attributes represented by X and Y Cartesian coordinates. Thus, in this example, draw k circles, based on an initial value of k, and find the corresponding k clusters. In one or more embodiments, the given parameters include k, as well as the radius of the circles. A least squares technique is used to assign each request to one of the clusters; effectively identifying k loci. In this regard, the distance between a request and the locus of a given cluster is proportional to error or cost. As is well known, in the least squares technique, the sum of the squares of the distances is minimized.

Thus, in step 404, determine the center for each cluster such that the distance from the chosen center to each request is minimized. In essence, what is being determined is which composite virtual appliances should be pre-provisioned to minimize overall cost. Here, in one or more embodiments, the distance is denoted by the total cost function. In at least some instances, this total cost function may include a weighted cost function including a weighted average of the provisioning cost, Aᵢ, the de-provision cost, D₁, and the cost associated with the update frequency U₁. In some instances, human experts in the field can be used to select the weights.

In step 406, choose an appropriate size for k based on the storage Sᵢ and permissible catalog size. Recall that an initial value of k was selected prior to step 402. It will be appreciated that if k is too large, an excessive number of composite virtual appliances will be pre-provisioned and that if k is too small, excessive provisioning time will be required to meet requests. In step 406, k can be selected to comply with pertinent constraints such as the available storage capacity, taking into account the required time and cost to maintain multiple golden images.

In one or more embodiments, pertinent attributes, represented by distances, include the install cost, uninstall cost, and update cost. In a preferred embodiment, the distance vector represents the weighted average labor and time for installation, update, and un-installation. For example, a particular case might involve availability of 1 terabyte of total storage. A very small value of k might easily satisfy the storage constraint but the cost to provision in response to requests might be too great. Another pertinent factor is the degree of variation in requests. Higher variation implies larger values of k and conversely, more uniform requests imply lower values of k.

In step 408, update this computation of the catalog every periodic interval, where the periodicity can be chosen, for example, based on request frequency, among other factors. Decision block 408 depicts logical flow returning back to step 402 if the periodic interval has elapsed, as per the “YES” branch; otherwise, continue to check whether the periodic interval has elapsed, as per the “NO” branch. Steps 406 and 408 thus can include, for example, periodically selecting a new value of k in an iterative manner.

In one or more embodiments, while carrying out the logic of flow chart 400, include invalidation cost as a metric in determining the above-discussed weighting factor(s).

With regard to an on-line technique (a technique for dynamically updating the catalog based on data collected over time as well as projections of future requests) refer to the flow chart 500 of FIG. 5, which begins at 501. Stated in another way, the process of FIG. 5 is dynamic and based, at least in part, on predictions of future requests, while the process of FIG. 4 is more static in nature. FIG. 5 takes into account the fact that people's behavior changes periodically. Here, look at past data (e.g., the last two months of requests) as well as predicted future requests. Predicted future requests are of significance in a cloud environment, in one or more embodiments, to avoid excessive response times to respond to requests as behavior changes.

Thus, in one or more embodiments, given that only a set of past requests are known, use the technique for determining the catalog, illustrated in the logic of flow chart 400 of FIG. 4, on the finite set of requests and the predicted request(s). Here, in addition to the past requests, prediction model-based requests are accounted together to design the k-center formulation. In step 502, determine request(s) from the current round of requests and add predicted requests (i.e., examine the history; in some instances, weighting more recent requests more heavily than older requests). In step 504, apply the technique for determining the catalog of FIG. 4 to determine the right number of k-cluster centers. In step 506, age the requests appropriately in the next round. In step 508, repeat step 504. Decision block 508 depicts logical flow returning back to step 504 if it is time for the next round, as per the “YES” branch; otherwise, continue to check whether it is time for the next round, as per the “NO” branch.

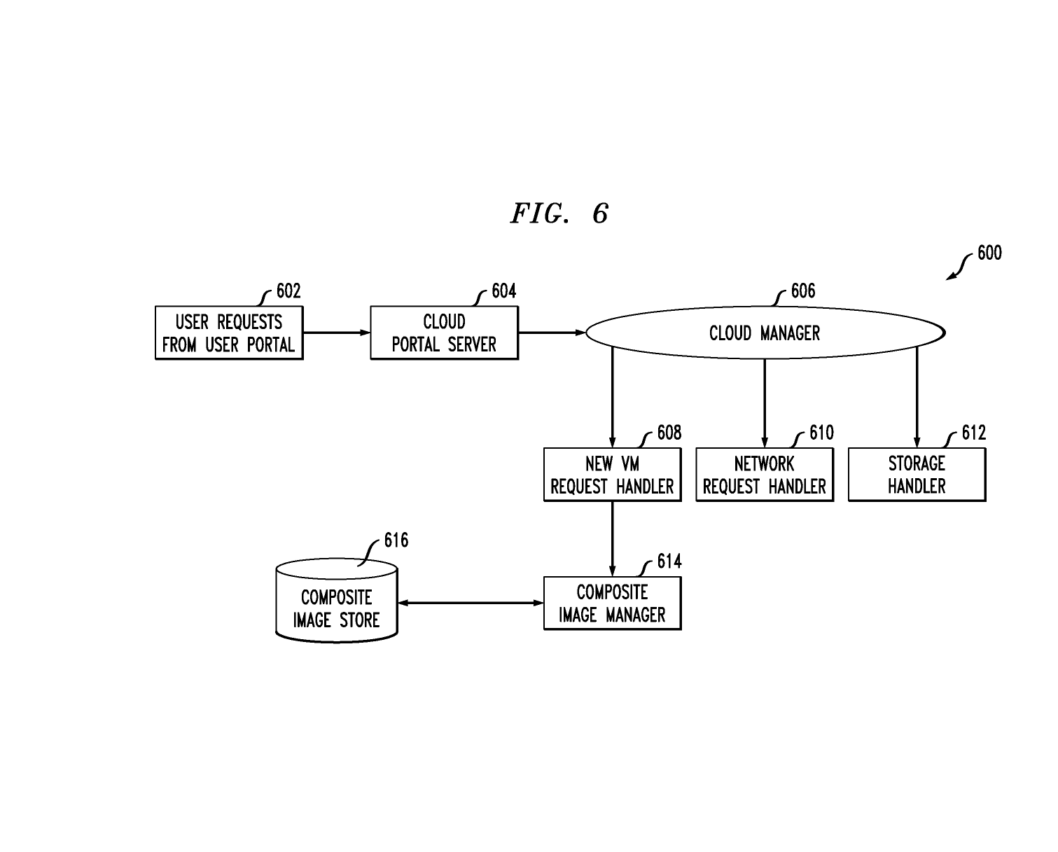

Attention should now be given to the exemplary system block diagram 600 of FIG. 6. The exemplary system 600 works as follows. The user 602 sends a request to the cloud from a user portal, using a browser to access cloud portal server 604. The request is to create a new compute node with specifics pertaining to “what” software stack. Cloud portal server 604 processes this request and sends it to cloud manager 606. Cloud manager 606 has various components to handle various types of requests. Non-limiting examples include new VM request handler 608, network request handler 610, and storage handler 612. The non-limiting exemplary architecture is for creation of a new compute node (virtual machine with right virtual appliance stack). Again, additional and/or different functionality can be provided in other cases. Upon receiving the request, cloud manager 606 then calls the new provision request handler 608, after some processing on its part. This component 608 then provides the software stack that the user needs to the composite image manager 614, with storage in store 616. Components 608, 614 cooperatively implement the logic in FIG. 4.

For the avoidance of doubt, the system diagram 600 is typically only part of the entire cloud operations—only the specifics to provisioning a new compute node is discussed in the non-limiting example.

Given the discussion thus far, it will be appreciated that, in general terms, an exemplary method, according to an aspect of the invention, includes the step of obtaining data representative of a set of requests for cloud computing services. The services are to be provided by a cloud having a plurality of base images. The requests specify requested subsets of the base images. An additional step includes obtaining data representative of provisioning and de-provisioning costs associated with the plurality of base images. A further step includes pre-provisioning k composite virtual appliances including virtual appliance subsets of the base images, based on cost minimization, in accordance with the data representative of the set of requests and the data representative of the provisioning and de-provisioning costs. The subsets of the base images that are included in the virtual appliances arc designated as “virtual appliance subsets” to distinguish them from the subsets of the base images specified in the requests, designates as requested subsets.

In some instances, the pre-provisioning step is further based on request frequency and update frequency for said plurality of base images. In some cases, further steps include clustering the data representative of the set of requests into k clusters having radii such that all of the requests are within at least one of the clusters, as at 402, and, for each of the k clusters, determining a center thereof such that a distance from each of the requests in a given one of the clusters to the center thereof is minimized, as at 404. The distance specifies, for each of the requests in the given one of the clusters, a weighted total cost. The centers correspond to the composite virtual appliances.

As shown, for example, in step 408, in some instances, periodically repeat the step of obtaining the data representative of the requests and the pre-provisioning step as additional data representative of additional sets of requests for cloud computing services is obtained. It will be appreciated that in such cases, the repeated step of obtaining the data representative of the requests includes obtaining the additional data. In the most general case, the additional data can include actual data, as more actual requests are obtained, and/or predicted data, as explained in connection with FIG. 5, for example.

An additional step in at least some instances includes actually fulfilling future requests for cloud computing services using the k pre-provisioned composite virtual appliances (in at least some instances, as such appliances may be updated from time-to-time).

It is worth noting that in some instances, excessive pre-provisioning may be harmful, especially with a “buggy” piece of software which needs to be frequently updated. This is due to the fact that significant amounts of time may be wasted maintaining the pre-provisioned composite images, since, as the “buggy” software gets updated, each pre-provisioned composite image must also be updated. On the other hand, items that do not need frequent updates are good candidates to build into composite images.

Furthermore, given the discussion thus far, it will be appreciated that, in general terms, an exemplary system, according to an aspect of the invention, includes a memory; and at least one processor, coupled to said memory, and operative to carry out or otherwise facilitate any one, some, or all of the method steps described herein. In some cases, the system includes a plurality of distinct software modules, each of which is embodied in a non-transitory manner on a non-transitory computer-readable storage medium. The distinct software modules can include, for example, any of the blocks or sub-blocks in FIG. 6, such as a cloud manager module and a composite image manager module.

It is worth mentioning that in one or more embodiments, k-centers can also be used to determine which of the pre-provisioned composite virtual appliances should be sued to fulfill a given request, during the provisioning phase. Simply see which one of the k-centers in the catalog the request attaches itself to.

Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 1, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 1) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. In the most general case, the program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). However, one or more embodiments are particularly significant in the context of a cloud or virtual machine environment employing a hypervisor or the like. Reference is made back to FIGS. 1-3 and accompanying text.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks (handlers 608, 610, 612 are non-limiting examples of sub-blocks/sub-modules) in FIG. 6, such as a cloud manager module and a composite image manager module. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining data representative of a set of requests for cloud computing services, said services to be provided by a cloud having a plurality of base images, wherein said requests specify requested subsets of said base images;
obtaining data representative of provisioning and de-provisioning costs associated with said plurality of base images; and
pre-provisioning k composite virtual appliances comprising virtual appliance subsets of said base images, based on cost minimization, in accordance with said data representative of said set of requests and said data representative of said provisioning and de-provisioning costs.

2. The method of claim 1, wherein said pre-provisioning step is further based on request frequency and update frequency for said plurality of base images.

3. The method of claim 2, further comprising:
clustering said data representative of said set of requests into k clusters having radii such that all of said requests are within at least one of said clusters; and
for each of said k clusters, determining a center thereof such that a distance from each of said requests in a given one of said clusters to said center thereof is minimized, wherein said distance specifies, for each of said requests in said given one of said clusters, a weighted total cost;
wherein said centers correspond to said composite virtual appliances.

4. The method of claim 1, further comprising periodically repeating said step of obtaining said data representative of said requests and said pre-provisioning step as additional data representative of additional sets of requests for cloud computing services is obtained, wherein said repeated step of obtaining said data representative of said requests comprises obtaining said additional data.

5. The method of claim 4, wherein at least some of said additional data comprises actual data.

6. The method of claim 4, wherein at least some of said additional data comprises predicted data.

7. The method of claim 1, further comprising fulfilling future requests for cloud computing services using said k pre-provisioned composite virtual appliances.

8. The method of claim 1, further comprising providing a system, wherein the system comprises distinct software modules, each of the distinct software modules being embodied on a computer-readable storage medium, and wherein the distinct software modules comprise a cloud manager module and a composite image manager module;
wherein:
said obtaining of said data representative of said set of requests is carried out by said cloud manager module executing on at least one hardware processor;
said obtaining of said data representative of said provisioning and de-provisioning costs is carried out by said cloud manager module executing on said at least one hardware processor; and
said pre-provisioning is carried out by said composite image manager module executing on said at least one hardware processor.

9. A system comprising:
a memory; and
at least one processor, coupled to said memory, and operative to:
obtain data representative of a set of requests for cloud computing services, said services to be provided by a cloud having a plurality of base images, wherein said requests specify requested subsets of said base images;
obtain data representative of provisioning and de-provisioning costs associated with said plurality of base images; and
pre-provision k composite virtual appliances comprising virtual appliance subsets of said base images, based on cost minimization, in accordance with said data representative of said set of requests and said data representative of said provisioning and de-provisioning costs.

10. The system of claim 9, wherein said at least one processor is operative to pre-provision based on request frequency and update frequency for said plurality of base images.

11. The system of claim 10, wherein said at least one processor is further operative to:
cluster said data representative of said set of requests into k clusters having radii such that all of said requests are within at least one of said clusters; and
for each of said k clusters, determine a center thereof such that a distance from each of said requests in a given one of said clusters to said center thereof is minimized, wherein said distance specifies, for each of said requests in said given one of said clusters, a weighted total cost;
wherein said centers correspond to said composite virtual appliances.

12. The system of claim 9, wherein said at least one processor is further operative to periodically repeat said step of obtaining said data representative of said requests and said pre-provisioning step as additional data representative of additional sets of requests for cloud computing services is obtained, wherein said repeated step of obtaining said data representative of said requests comprises obtaining said additional data.

13. The system of claim 12, wherein at least some of said additional data comprises actual data.

14. The system of claim 12, wherein at least some of said additional data comprises predicted data.

15. The system of claim 9, wherein said at least one processor is further operative to fulfill future requests for cloud computing services using said k pre-provisioned composite virtual appliances.

16. The system of claim 9, further comprising a plurality of distinct software modules, each of the distinct software modules being embodied in a non-transitory manner on a non-transitory computer-readable storage medium, and wherein the distinct software modules comprise a cloud manager module and a composite image manager module;
wherein:
said at least one processor is operative to obtain said data representative of said set of requests by executing said cloud manager module;
said at least one processor is operative to obtain said data representative of said provisioning and de-provisioning costs by executing said cloud manager module; and
said at least one processor is operative to pre-provision is by executing said composite image manager module.

17. An article of manufacture comprising a computer program product, said computer program product in turn comprising:
a non-transitory tangible computer-readable storage medium, storing in a non-transitory manner computer readable program code, the computer readable program code comprising:
computer readable program code configured to obtain data representative of a set of requests for cloud computing services, said services to be provided by a cloud having a plurality of base images, wherein said requests specify requested subsets of said base images;
computer readable program code configured to obtain data representative of provisioning and de-provisioning costs associated with said plurality of base images; and
computer readable program code configured to pre-provision k composite virtual appliances comprising virtual appliance subsets of said base images, based on cost minimization, in accordance with said data representative of said set of requests and said data representative of said provisioning and de-provisioning costs.

18. The article of manufacture of claim 17, wherein said computer readable program code configured to pre-provision is configured to pre-provision based on request frequency and update frequency for said plurality of base images.

19. The article of manufacture of claim 18, further comprising:
computer readable program code configured to cluster said data representative of said set of requests into k clusters having radii such that all of said requests are within at least one of said clusters; and
computer readable program code configured to, for each of said k clusters, determine a center thereof such that a distance from each of said requests in a given one of said clusters to said center thereof is minimized, wherein said distance specifies, for each of said requests in said given one of said clusters, a weighted total cost;
wherein said centers correspond to said composite virtual appliances.

20. The article of manufacture of claim 17, further comprising computer readable program code configured to periodically repeat said step of obtaining said data representative of said requests and said pre-provisioning step as additional data representative of additional sets of requests for cloud computing services is obtained, wherein said repeated step of obtaining said data representative of said requests comprises obtaining said additional data.

21. The article of manufacture of claim 20, wherein at least sonic of said additional data comprises actual data.

22. The article of manufacture of claim 20, wherein at least some of said additional data comprises predicted data.

23. The article of manufacture of claim 17, further comprising computer readable program code configured to fulfill future requests for cloud computing services using said k pre-provisioned composite virtual appliances.

24. An apparatus comprising:
means for obtaining data representative of a set of requests for cloud computing services, said services to be provided by a cloud having a plurality of base images, wherein said requests specify requested subsets of said base images;
means for obtaining data representative of provisioning and de-provisioning costs associated with said plurality of base images; and
means for pre-provisioning k composite virtual appliances comprising virtual appliance subsets of said base images, based on cost minimization, in accordance with said data representative of said set of requests and said data representative of said provisioning and de-provisioning costs.

25. The apparatus of claim 24, wherein said means for pre-provisioning further base said pre-provisioning on request frequency and update frequency for said plurality of base images, further comprising:
means for clustering said data representative of said set of requests into k clusters having radii such that all of said requests are within at least one of said clusters; and
means for, for each of said k clusters. determining a center thereof such that a distance from each of said requests in a given one of said clusters to said center thereof is minimized, wherein said distance specifies, for each of said requests in said given one of said clusters, a weighted total cost;
wherein, said centers correspond to said composite virtual appliances.
